(19) United States
(12) Patent Application Publication
(10) Pub. No.: US 2009/0243793 A1
(43) Pub. Date: Oct. 1, 2009

(54) Vehicle Carrying Remote Control Apparatus And Control Method Thereof

(76) Inventor: Cheng-Chi Hsu, Taichung (TW)

Correspondence Address: LIN & ASSOCIATES INTELLECTUAL PROPERTY, INC., P.O. BOX 2339, SARATOGA, CA, 95070-0339, US

(21) Appl. No.: 12/060,264

(22) Filed: Apr. 1, 2008

(51) Int. Cl. G05B 19/00

(52) U.S. Cl. 340/5.7

(57) ABSTRACT

A vehicle carrying remote control apparatus is provided. The vehicle carrying remote control apparatus is adapted for a security mechanism, e.g., a driveway gate or a mechanical parking lot, which can be remote controlled for allowing a vehicle to pass while the vehicle is being driven, and can be remote controlled to open for passing and close for blocking. The vehicle carrying remote control apparatus includes a control module, and an antenna. The control module includes a fixing base, at least more than one electronic control panels, at least one set of control keys and a signal output terminal. The antenna is equipped to the vehicle, for receiving the signal outputted by the signal output terminal and transmitting the same to a sensing apparatus of a sensing apparatus of the security mechanism.

### BACKGROUND OF THE INVENTION

1. Field of the Invention

The present invention relates generally to a vehicle carrying remote control apparatus and a control method thereof, and more particularly, to a control module and an antenna which can be set and equipped to or taken off from a vehicle. With such a control module equipped thereto when properly set and controlled, the vehicle can achieve a better driving safety, and be more conveniently and accurately controlled.

2. The Prior Arts

Modern buildings are very often designed with driveway gates, mechanical parking lots, or even auto-gates which are controlled to open/close by a handheld remote control. However, a typical remote control provided in the current market is often designed for specifically controlling a certain item. Unfortunately, current city people usually have many sites to frequently visit, such as home, working site, private recreation place, most of which are equipped with security protection systems. As such, many people are used to take more than one remote controls. It may be okay in usual. However, when controlling a driveway gate or a mechanical parking lot, during which the driver is often driving the vehicle, the driver must take out the remote control and operate before approaching to the driveway gate or the mechanical parking lot. In such a way, it is very often that a driver is looking for or holding a remote control to aim the antenna for controlling while driving at the same time. It is a serious threat for the driver, because it often causes the vehicle out of control. In some difficult conditions, the driveway gate, the antenna for the mechanical parking lot may be installed in an inconvenient position or there exists a ramp when accessing, or there are other vehicles nearby, which even aggravates the risk.

In another hand, it is also conventional to open the driveway gate or the mechanical parking lot when the authorized vehicle accesses to a certain distance by receiving an indicating signal in a manner of active sensing. Even though simple and convenient for use, the active sensing provides no adaptability to the use in optionally selecting to open or close the driveway gate or the mechanical parking lot as desired. However, if the user cannot actively select the time for opening or closing the driveway gate or the mechanical parking lot, he is thus incapable of stopping unauthorized individual or vehicle to enter subsequently. This may be utilized by malevolent people to enter unauthorized private property. Further, such an active sensing design is typically designed with security measure, e.g., emergency stopping or delay closing after opening the driveway gate, for the purpose of avoiding injuring people due to a time error in closing the gate. As such, subsequently entered individual or vehicle will be seldom stopped. This very much threats the security of those authorized vehicles. Moreover, when a user takes many remote controls, it is also bothering to find out or identify the correct one for use. As such, it becomes a desirable concern to develop an apparatus and a control method for conveniently and accurately remotely controlling an operation of a driveway gate or a mechanical parking lot, while also considering the security mechanism.

### SUMMARY OF THE INVENTION

In order to compensate the disadvantage of the conventional remote control and the control method thereof, the present invention provides a vehicle carrying remote control apparatus and a control method thereof. The vehicle carrying remote control apparatus and a control method thereof allow a driver to easily and conveniently control the operation of a driveway gate or a mechanical parking lot when driving the vehicle, so as to avoid the threat of inattention caused by handholding the remote control when driving, and provide a solution to a poor controllability caused by a poor signal transmittance of the remote control, and therefore are safer.

A primary objective of the present invention is to provide a vehicle carrying remote control apparatus. The vehicle carrying remote control apparatus is adapted for a security mechanism, e.g., a driveway gate or a mechanical parking lot, which can be remote controlled for allowing a vehicle to pass while the vehicle is being driven, and can be remote controlled to open for passing and close for blocking.

The vehicle carrying remote control apparatus includes a control module, and an antenna. The control module includes a fixing base, at least more than one electronic control panels, at least one set of control keys and a signal output terminal. The fixing base includes an assembly portion configured at an external thereof provided for being assembled inside the vehicle. The fixing base further includes a connection portion. The electronic control panels are disposed at a position of the connection portion and receive a control signal generated by operation of the control keys. The control keys are assembled and disposed at a surface of the fixing base. The signal output terminal is electrically connected with the electronic control panel, and is adapted to output a signal generated by the electronic control panels. The connection portion is connected to an external power supply for providing power. The antenna is equipped to the vehicle, for receiving the signal outputted by the signal output terminal and transmitting the same to a sensing apparatus of a sensing apparatus of the security mechanism.

The present invention is further directed to a control method for a vehicle carrying remote control apparatus, which is adapted for a security mechanism which can be remote controlled for allowing a vehicle to pass while the vehicle is being driven, and can be remote controlled to open for passing and close for blocking.

The control method includes the steps of: selecting a specific number of items for remote controlling, setting or replicating frequencies of the specific number of items to electronic control panels, and fixing the electronic control panel to a fixing base; equipping the fixing base to a desired position of the vehicle via an assembly portion of the fixing base, and then equipping an antenna at a suitable position of the vehicle, so as to build a signal communication between the antenna and a signal output terminal of the fixing base; when the vehicle is driven to a specific position and waiting for remote controlling a sensing apparatus for initiating an opening operation, selecting a corresponding opening control key for remote controlling the sensing apparatus, wherein when there are more than one electronic control panels, a user selects a corresponding one of the electronic control panels with a control key, and remote controlling the sensing apparatus to drive the vehicle gate or the mechanical parking lot to open, the vehicle gate and the mechanical parking lot allowing the vehicle to pass, and being adapted to open for passing and close for stopping; when the vehicle is driven over the specific position and waiting for remote controlling the sensing apparatus for initiating a closing operation, selecting a corresponding closing control key for remote controlling the sensing apparatus, wherein when there are more than one electronic control panels, the user remote controls the sensing apparatus to drive the vehicle gate or the mechanical parking lot to close, the vehicle gate or the mechanical parking lot allowing the vehicle to pass; and when the vehicle is driven over the specific position and waiting for remote controlling the sensing apparatus for initiating a stopping operation, selecting a corresponding stopping control key for remote controlling the sensing apparatus, wherein when there are more than one electronic control panels, the user remote controls the sensing apparatus to drive the vehicle gate or the mechanical parking lot to stop.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram illustrating the control of a circuit according to an embodiment of the present invention;

FIG. 2 is a schematic diagram illustrating the structural status after being equipped according to an embodiment of the present invention;

FIG. 3 is a schematic diagram illustrating the assembly configuration according to an embodiment of the present invention;

FIG. 4 is a schematic diagram illustrating the assembly configuration according to another embodiment of the present invention;

FIG. 5 illustrates a control status of a first application of the present invention;

FIG. 6 illustrates another control status of a second application of the present invention;

FIG. 7 illustrates a control status of a first application of the present invention; and

FIG. 8 illustrates another control status of a second application of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

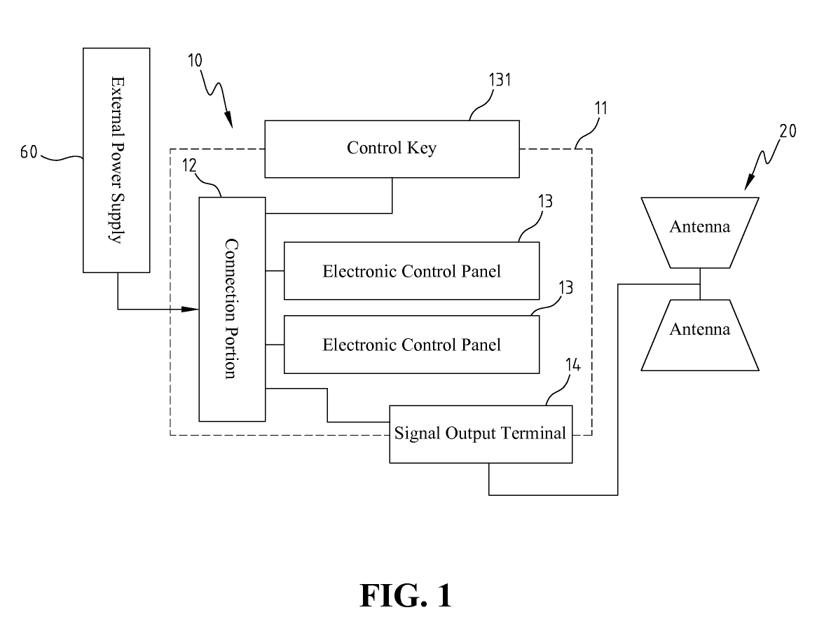

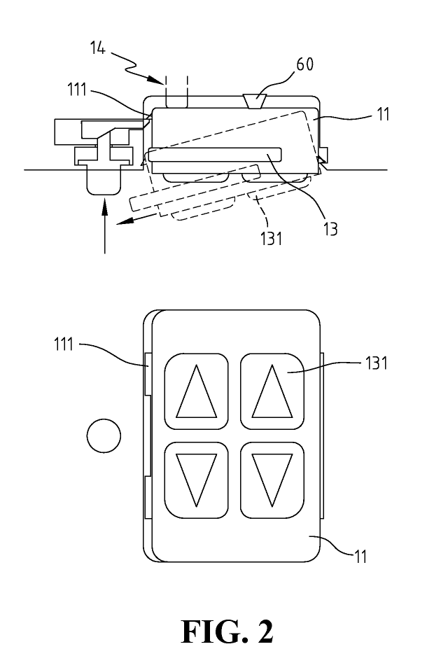

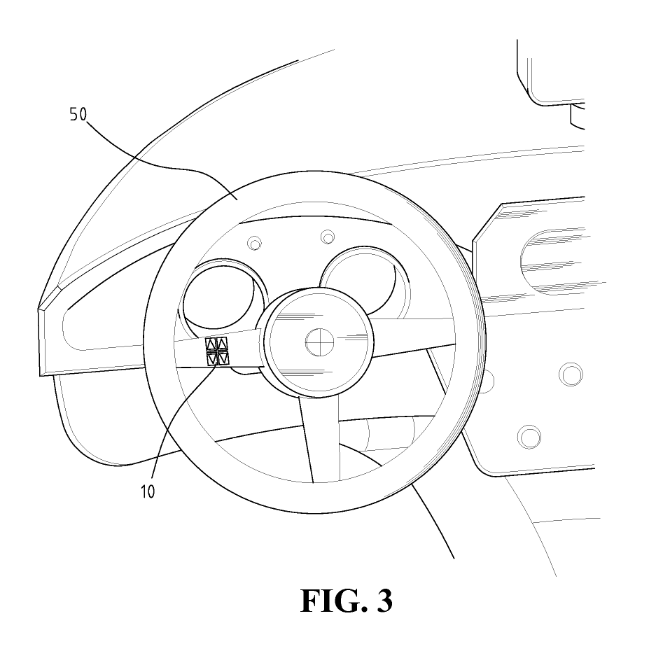

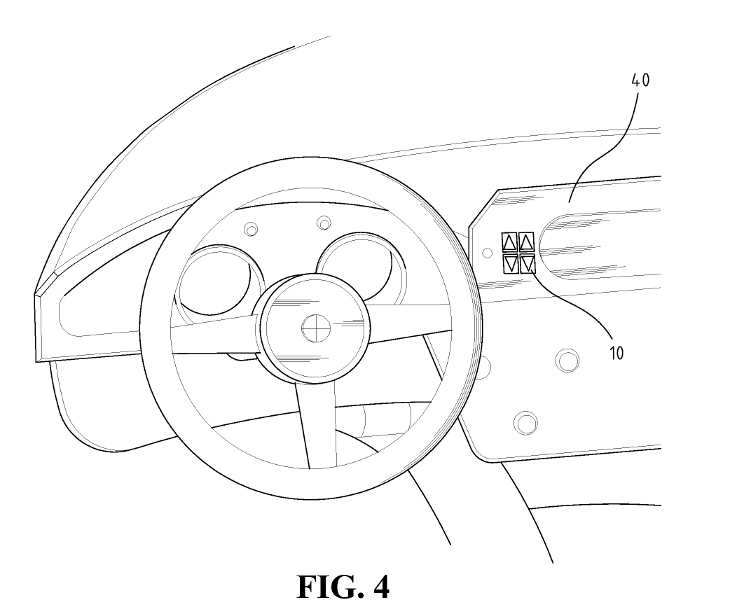

Referring to FIGS. 1 through 4, according to an embodiment of the present invention, a vehicle carrying remote control apparatus is provided hereby. The vehicle carrying remote control apparatus includes a settable control module 10, and an antenna 20. The control module 10 is equipped to a predetermined position of the vehicle. The antenna 20 is equipped to the vehicle and preferably along a longitudinal direction relative to the vehicle. The control module 10 includes a fixing base 11 which is detachable. The fixing base 11 is configured as a housing including an assembly portion 111, by which the fixing base 11 can be assembled inside the vehicle at a desired position, e.g., where convenient to operate while requiring less eyesight for viewing such as monitoring panel 40, and steering wheel 50. The fixing base 11 further includes at least one connection portion 12. The connection portion 12 includes a receiving space adapted for receiving and connecting more than one electronic control panels 13 each having at least one control key 131. Each of the electronic control panels 13 is adapted to receive a control signal generated by operation of the control key 131. The control key 131 is assembled and disposed at a surface of the fixing base 11. The fixing base 11 further includes a signal output terminal 14 electrically connected with the electronic control panel 13. The signal output terminal 14 is adapted to output a signal generated by the electronic control panel 13. The electronic control panel 13, when taken off from the fixing base 11, can be set to vary a frequency and number of the outputted signal for correspondingly controlling a specific sensing apparatus 30. After set, the electronic control panel 13 can be reassembled back to the fixing base 11 for further operation.

According to an aspect of the embodiment, when there include a plurality of electronic control panels 13, the electronic control panels 13 can be designed with a function of integral calculation so as to provide a modular entire control for controlling different sensing apparatus 30. Each of the electronic control panels 13 is designed with at least an opening/closing operation for process controlling, and optionally a stopping operation for action controlling. Correspondingly, each electronic control panel 13 is designed with a certain number of the control keys 131 in accordance with the foregoing operations. In addition, when there include a plurality of electronic control panels 13, each of the electronic control panel 13 may further includes a control key 13 for controlling the electronic control panel 13 to switch between different operations.

The assembly portion 111 can be assembled to the vehicle by a predesigned assembly opening at the monitoring panel 40 or the steering wheel 50 or by a matching structure introduced to an external connectable fixing position in the vehicle. The assembly portion 111 can be assembled by engaging, screwing, banding, or sticking.

The connection portion 12 is preferably configured to be a terminal, slot or other structures for electrical connection or signal transmission. The electronic control panel 13 is an electronic circuit structure capable of performing a calculation. The signal output terminal 14 is adapted to transmit a signal by either a signal line connection or a wireless signal connection with a signal transmission scope restricted within the vehicle. The sensing apparatus 30 is a wireless signal communication apparatus connected with the driveway gate or the mechanical parking lot via a control apparatus to drive the same to open or close.

The antenna 20 is equipped to the vehicle, for receiving the signal outputted by the signal output terminal 14 and transmitting the same toward a certain direction to the sensing apparatus 30 for receiving. The antenna 20 is preferably designed for a dual-directional emitting with a front emitting direction and a rear emitting direction, so as to allow the sensing apparatus 30 to receive the signal outputted from the antenna 20 either from the front direction or from the rear direction. The antenna 20 is communicable with the signal output terminal 14 either by a wire connected therebetween or a wireless connection constructed therebetween. As such, a user is allowed to select one or more electronic control panels 13 according to the items to be remote controlled, and correspondingly set different control frequencies according to the items to be controlled. Then, the user can equip the electronic control panels 13 back to the control module 10. The fixing base 11 may be correspondingly configured with a single or a certain number of connection portions 12 and terminals surfaces for the control keys 131 equipped to the fixing base 11.

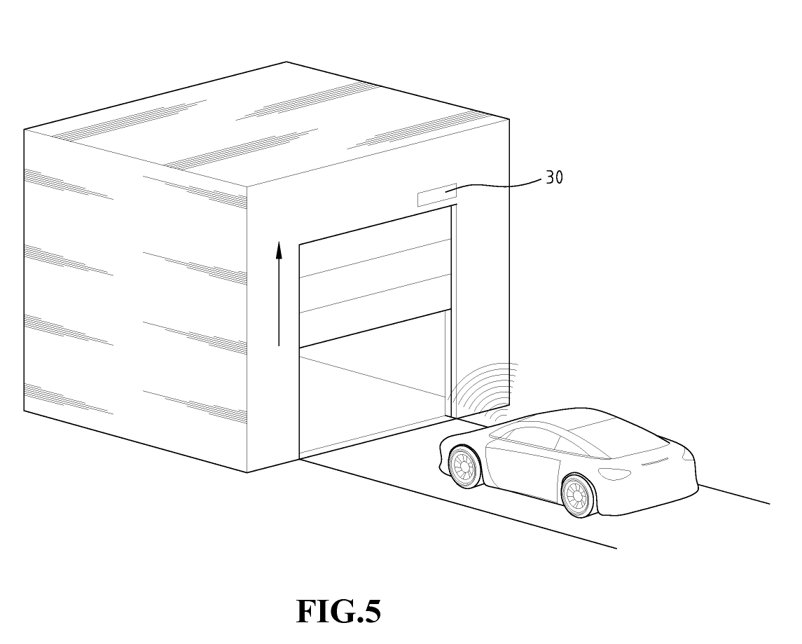

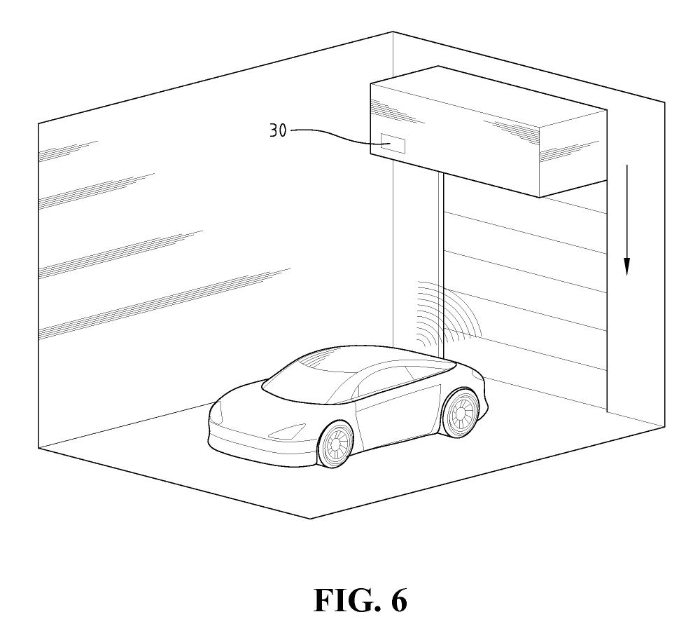

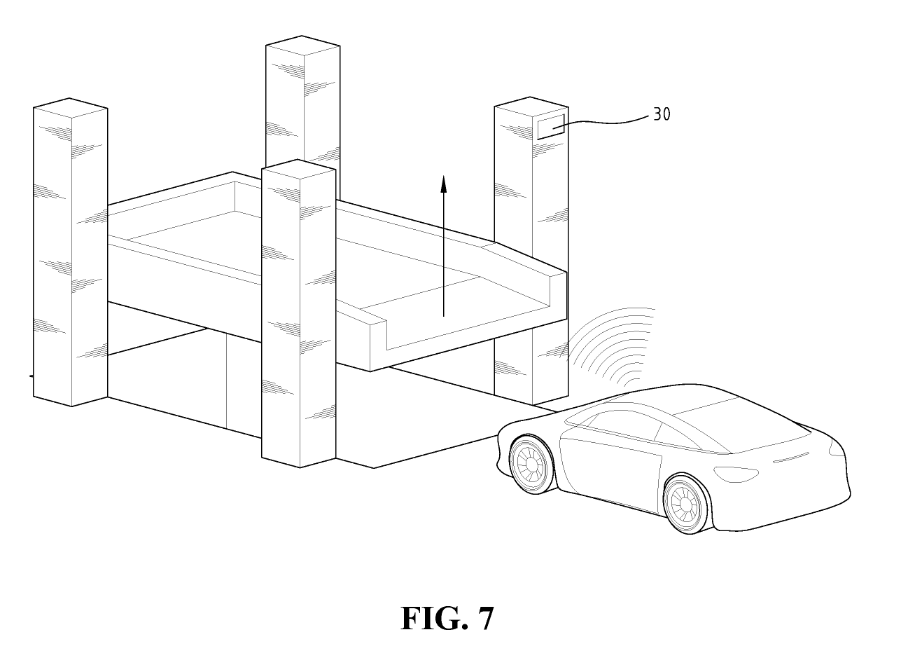

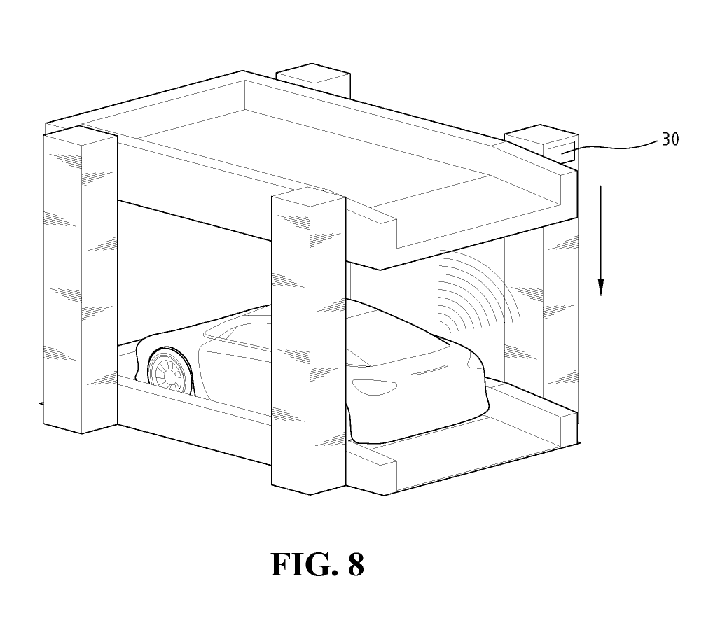

Now referring to FIGS. 5-8, there is shown a procedure illustrating a control method according to the present invention to perform a single or a plurality of actions by the control module 10. Firstly, the user selects a specific number of items for remote controlling, and then preparing a fixing base 11 corresponding to the specific number. The user then takes off the electronic control panels 13, and then sets or replicates frequencies of the specific number of items to the electronic control panels 13, respectively. Then, after completing the setting, the user then fixes the electronic control panels 13 back to a connection portion 12 of the fixing base 11. Then, the fixing base 11 is equipped to a desired position of the vehicle via an assembly portion 111 of the fixing base 11. Then an antenna 20 is equipped at a suitable position of the vehicle, so as to build a signal communication between the antenna 20 and a signal output terminal 14 of the fixing base 11. The connection portion 12 is provided with power from an external power supply connected thereto.

Upon completion of installation of the foregoing components to the vehicle, the control module 10 can be processed in daily use. When the vehicle is driven to a specific position and waiting for remote controlling a sensing apparatus 30 for initiating an operation, the user selects a corresponding control key 131 for remote controlling the sensing apparatus 30. When there are more than one electronic control panels 13, the user can select a corresponding one of the electronic control panels 13 with a control key before remote controlling the sensing apparatus 30 to drive the vehicle gate or the mechanical parking lot to open/close or stop.

When the vehicle is driven to pass, the user may select to transmit an opening instruction signal via the antenna 20 to the sensing apparatus 30 so as to instruct the driveway gate or the mechanical parking lot to open, according to the ambient condition. In a similar manner, after the vehicle passes, the user can select to transmit a closing instruction signal via the antenna 20 to the sensing apparatus 30 so as to instruct the driveway gate or the mechanical parking lot to close, according to the ambient condition. Specifically, upon awareness of an emergency condition, the user may select to use an emergency stopping control key to stop any operation of the driveway gate or the mechanical parking lot. According to an aspect of the embodiment, when the opening control key is pressed, a corresponding signal is emitted forwardly, when the closing control key is pressed, a corresponding signal is emitted backwardly, and when the emergency stopping control key is pressed, a signal is transmitted both forwardly and backwardly via the antenna 20. When the vehicle is driven to another sensing apparatus 30 of a next item for remote controlling, the user can switch the electronic control panel 13 corresponding thereto via the control key 131, and then performs operations as discussed above.

In summary, the present invention is provided to avoid threat and risks caused by the conventional apparatus and methods. The present invention even improves the usability and convenience of using a remote control by integrating the operation of a plurality of control actions at a convenient position of the vehicle so as to allow the user to easily control the driveway gate or the mechanical parking lot according to ambient conditions, and thus improving the safety.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A vehicle carrying remote control apparatus, adapted for a security mechanism which can be remote controlled for allowing a vehicle to pass while the vehicle is being driven, and can be remote controlled to open for passing and close for blocking, the vehicle carrying remote control apparatus comprising:
a control module, comprising:
a fixing base, having an assembly portion configured at an external thereof provided for being assembled inside the vehicle, and a connection portion connected to an external power supply for providing power;
at least more than one electronic control panels, disposed at a position of the connection portion and receiving a control signal generated by operation of the control keys;
at least one set of control keys, assembled and disposed at a surface of the fixing base; and
a signal output terminal, electrically connected with the electronic control panels, and adapted to output a signal generated by the electronic control panels; and
an antenna, equipped to the vehicle, for receiving the signal outputted by the signal output terminal and transmitting the same to a sensing apparatus of the security mechanism which can be remote controlled for allowing a vehicle to pass while the vehicle is being driven, and can be remote controlled to open for passing and close for blocking.

2. The vehicle carrying remote control apparatus according to claim 1, wherein the fixing base is a housing having an assembly portion, by which the fixing base can be assembled inside the vehicle at a desired position, where convenient to operate while requiring less eyesight for viewing.

3. The vehicle carrying remote control apparatus according to claim 1, wherein the assembly portion is assembled to the vehicle by a predesigned assembly opening at a monitoring panel or a steering wheel, or by a matching structure introduced to an external connectable fixing position in the vehicle, wherein the assembly portion is assembled thereto by engaging, screwing, banding, or sticking.

4. The vehicle carrying remote control apparatus according to claim 1, wherein the connection portion is configured to be a terminal, or a slot for electrical connection or signal transmission.

5. The vehicle carrying remote control apparatus according to claim 1, wherein the electronic control panel is an electronic circuit structure capable of performing a calculation.

6. The vehicle carrying remote control apparatus according to claim 1, wherein the signal output terminal is adapted to transmit a signal by either a signal line connection or a wireless signal connection.

7. The vehicle carrying remote control apparatus according to claim 1, wherein the antenna is capable of emitting a signal forwardly and backwardly.

8. A control method for a vehicle carrying remote control apparatus, which is adapted for a security mechanism which can be remote controlled for allowing a vehicle to pass while the vehicle is being driven, and can be remote controlled to open for passing and close for blocking, the control method comprising:
selecting a specific number of items for remote controlling, setting or replicating frequencies of the specific number of items to one or more electronic control panels, and fixing the electronic control panels to a fixing base;
equipping the fixing base to a desired position of the vehicle via an assembly portion of the fixing base, and then equipping an antenna at a suitable position of the vehicle, so as to build a signal communication between the antenna and a signal output terminal of the fixing base;
when the vehicle is driven to a specific position and waiting for remote controlling a sensing apparatus for initiating an opening operation, selecting a corresponding opening control key for remote controlling the sensing apparatus, wherein when there are more than one electronic control panels, a user selects a corresponding one of the electronic control panels with a control key, and remote controlling the sensing apparatus to drive the vehicle gate or the mechanical parking lot to open, the vehicle gate and the mechanical parking lot allowing the vehicle to pass, and being adapted to open for passing and close for stopping;
when the vehicle is driven over the specific position and waiting for remote controlling the sensing apparatus for initiating a closing operation, selecting a corresponding closing control key for remote controlling the sensing apparatus, wherein when there are more than one electronic control panels, the user remote controls the sensing apparatus to drive the vehicle gate or the mechanical parking lot to close, the vehicle gate or the mechanical parking lot allowing the vehicle to pass; and
when the vehicle passes the specific position and waiting for remote controlling the sensing apparatus for initiating an emergency stopping operation, selecting a corresponding emergency stopping control key for remote controlling the sensing apparatus, wherein when there are more than one electronic control panels, the user remote controls the sensing apparatus to drive the vehicle gate or the mechanical parking lot to stop any operation.

9. The vehicle carrying remote control apparatus according to claim 8, wherein when the opening control key is pressed, a corresponding signal is emitted forwardly; when the closing control key is pressed, a corresponding signal is emitted backwardly; and when the emergency stopping control key is pressed, a signal is transmitted both forwardly and backwardly via the antenna
